(19) United States
(12) Patent Application Publication
(10) Pub. No.: US 2025/0303852 A1
(43) Pub. Date: Oct. 2, 2025

(54) INDUSTRIAL VEHICLE

(71) Applicant: KABUSHIKI KAISHA TOYOTA JIDOSHOKKI, Kariya-shi (JP)

(72) Inventor: Daiki ISHIDA, Kariya-shi (JP)

(73) Assignee: KABUSHIKI KAISHA TOYOTA JIDOSHOKKI, Kariya-shi (JP)

(21) Appl. No.: 19/088,182

(22) Filed: Mar. 24, 2025

(30) Foreign Application Priority Data
Mar. 28, 2024 (JP) 2024-054707

(51) Int. Cl. B60K 11/06; B60K 1/00; B60L 1/00; B60L 15/20; B60L 50/60; B66F 9/075

(52) U.S. Cl. CPC B60K 11/06; B60K 1/00; B60L 1/003; B60L 15/20; B60L 50/60; B66F 9/07572; B60K 2001/006; B60L 2200/42

(57) ABSTRACT

An industrial vehicle includes a vehicle body, a vehicle load, a drive motor, a motor controller, and a cooling device. The vehicle body accommodates the drive motor, the motor controller, and the cooling device. The cooling device includes a first cooling duct and a second cooling duct. The first cooling duct includes an inlet port, an outflow branch port, and an outlet port. The second cooling duct includes an inflow branch port and a discharge port. The motor controller is connected to the first cooling duct so as to exchange heat with the air flowing in a section that is downstream of the outflow branch port and upstream of the outlet port. The drive motor is connected to the second cooling duct so as to be cooled by air discharged from the discharge port.

### CROSS-REFERENCE TO RELATED APPLICATIONS

This application is based upon and claims the benefit of priority from Japanese Patent Application No. 2024-054707, filed on Mar. 28, 2024, the entire contents of which are incorporated herein by reference.

### BACKGROUND

### 1. Field

The present disclosure relates to an industrial vehicle.

### 2. Description of Related Art

Japanese Laid-Open Patent Publication No. 2023-149063 discloses a forklift that uses a battery as a power source. The forklift includes a vehicle body, a traction motor and a material-handling motor, which are drive motors, a battery, a motor controller, and a cooling fan. The vehicle body accommodates the traction motor, the material-handling motor, the battery, the motor controller, and the cooling fan. The traction motor and the material-handling motor are driven by power supplied from the battery. The motor controller controls the operation of the traction motor and the material-handling motor. The cooling fan is arranged rearward of the traction motor and the material-handling motor in the forklift.

When the forklift is traveling, a motion-generated air flow is introduced into the vehicle body from the front of the forklift. The motion-generated air flow introduced into the vehicle body flows from the front to the rear of the forklift under the action of the cooling fan. The traction motor, the material-handling motor, and the motor controller are cooled by the motion-generated air flow.

In battery-powered forklifts that use a battery as a power source, it is desirable to improve the cooling performance for the drive motors and the motor controller to enable operation under a relatively high output of the battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an industrial vehicle includes a vehicle body provided with a vehicle load and a battery, a drive motor that is configured to receive electric power from the battery so as to drive the vehicle load, and a motor controller configured to control the drive motor. The vehicle body includes an accommodation space that accommodates the drive motor and the motor controller, and an opening that connects the accommodation space to an exterior of the vehicle body. The accommodation space accommodates a first cooling duct and a second cooling duct. The first cooling duct includes an inlet port connected to the exterior of the vehicle body through the opening, an outlet port through which air that has flowed into the first cooling duct through the inlet port flows out from the first cooling duct, and an outflow branch port in a section downstream of the inlet port and upstream of the outlet port. The second cooling duct includes an inflow branch port connected to the outflow branch port, and a discharge port through which air that has flowed into the second cooling duct through the inflow branch port is discharged from the second cooling duct. The motor controller is connected to the first cooling duct so as to exchange heat with air flowing in a section that is downstream of the outflow branch port and upstream of the outlet port. The drive motor is connected to the second cooling duct so as to be cooled by air discharged from the discharge port.

Other features and aspects will be apparent from the following detailed description, the drawings, and the claims.

### BRIEF DESCRIPTION OF THE DRAWINGS

FIG. 1 is a side view of a forklift.

FIG. 2 is a cross-sectional view schematically showing the forklift shown in FIG. 1.

FIG. 3 is a schematic cross-sectional plan view partially showing the interior of the forklift shown in FIG. 1.

FIG. 4 is a schematic perspective view partially showing the interior of a vehicle body.

FIG. 5 is a perspective view showing a cooling device.

FIG. 6 is an exploded perspective view showing a first cooling duct and a motor controller.

FIG. 7 is a perspective view partially showing a second cooling duct.

FIG. 8 is a cross-sectional view partially showing the second cooling duct shown in FIG. 7.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

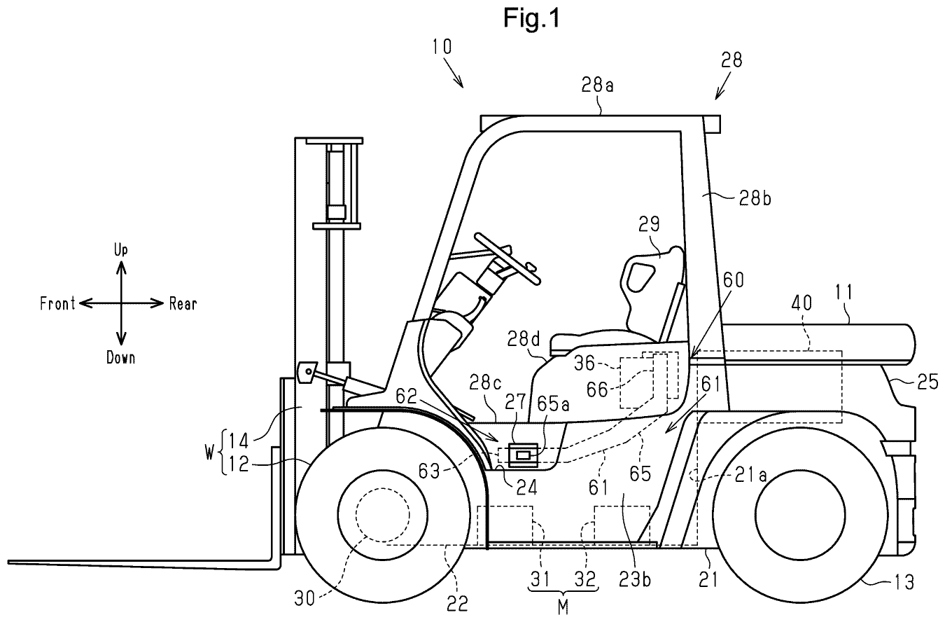

An industrial vehicle according to an embodiment will now be described with reference to FIGS. 1 to 8. The industrial vehicle of the present embodiment is a forklift 10. In the following description, the forward, rearward, leftward, rightward, upward, and downward directions are defined with reference to a state in which the operator of the forklift 10 faces the advancing direction of the forklift 10.

### Overall Structure of the Forklift 10

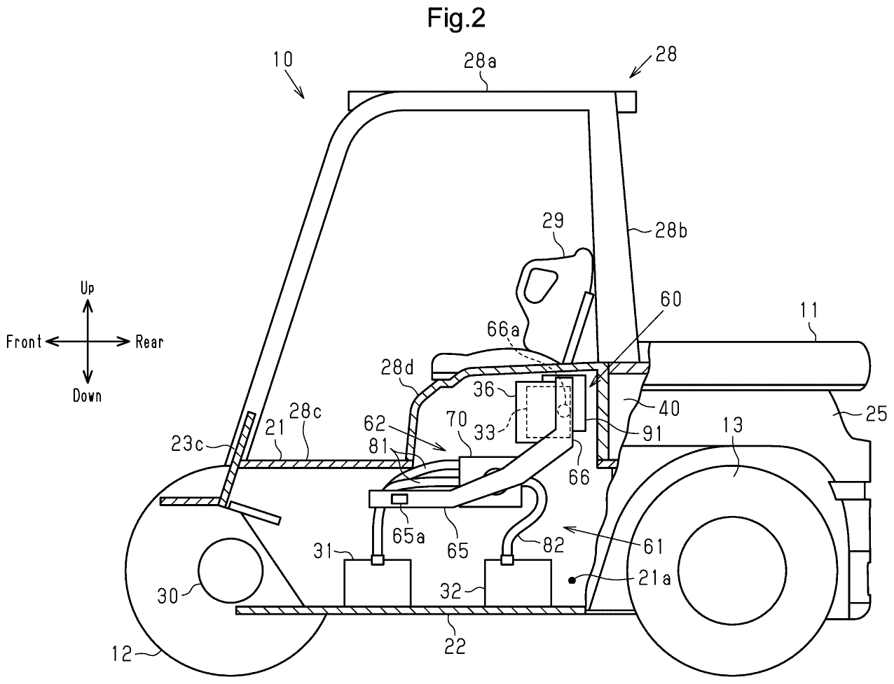

As shown in FIGS. 1 and 2, the forklift 10 includes a vehicle body 11, steered wheels 13, and vehicle loads W. The vehicle loads W include two drive wheels 12 and a material-handling device 14.

The forklift 10 includes drive motors M, a driving force transmitting device 30, and a motor controller 33. The drive motors M include two traction motors 31 and a material-handling motor 32. The drive motors M drive the vehicle loads W. Specifically, the traction motors 31 drive the drive wheels 12. The material-handling motor 32 drives the material-handling device 14. The motor controller 33 controls the drive motors M. The forklift 10 includes the drive motors M, which drive the material-handling device 14 and the drive wheels 12. The forklift 10 includes a battery 40. The traction motors 31 and the material-handling motor 32 use the battery 40 provided in the vehicle main body 21 as a power source. The forklift 10 includes a cooling device 60. The cooling device 60 cools the traction motors 31, the material-handling motor 32, and the motor controller 33.

The driving force transmitting device 30 is connected to the traction motors 31. Rotation of each traction motor 31 is transmitted to the corresponding drive wheel 12 via the driving force transmitting device 30. The forklift 10 travels by driving the drive wheels 12 through the traction motors 31 and the driving force transmitting device 30.

### Vehicle Body 11

The vehicle body 11 includes a vehicle main body 21 and a cabin 28 arranged on the vehicle main body 21. The cabin 28 incorporates a driver's seat 29. In the following description, the front-rear direction is the front-rear direction of the vehicle body 11, and the left-right direction is the width direction of the vehicle body 11. The vehicle main body 21 is provided with the material-handling device 14 and the drive wheels 12. The material-handling device 14 is provided in front of the vehicle main body 21.

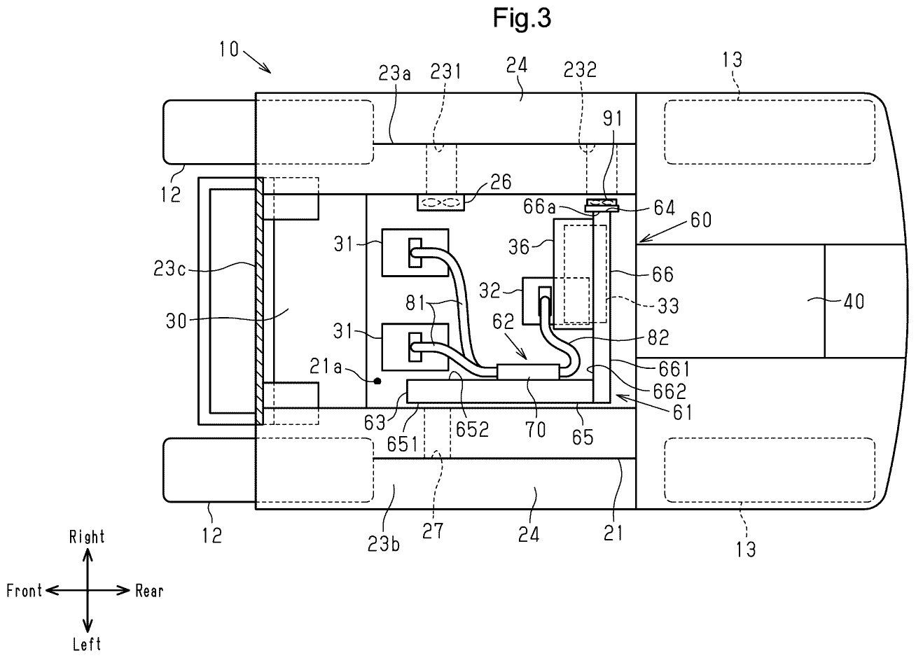

As shown in FIGS. 2 and 3, the vehicle main body 21 includes a bottom portion 22, a right-side portion 23a, a left-side portion 23b, and a front partition plate 23c. The vehicle main body 21 includes two footsteps 24 and a counterweight 25. The right-side portion 23a and the left-side portion 23b are spaced apart in the left-right direction. The right-side portion 23a and the left-side portion 23b are located forward of the counterweight 25. The front partition plate 23c spans between the front part of the right-side portion 23a and the front part of the left-side portion 23b. The front partition plate 23c forms a part of the front end of the vehicle main body 21. The front partition plate 23c is located in front of and above the bottom portion 22.

The footsteps 24 are respectively provided on the right-side portion 23a and the left-side portion 23b. The footsteps 24 are formed by the lower parts of the right-side portion 23a and the left-side portion 23b bulging outward from the vehicle main body 21 in the left-right direction. The bottom portion 22 spans between the lower part of the right-side portion 23a and the lower part of the left-side portion 23b. The bottom portion 22 is located forward of the counterweight 25.

The right-side portion 23a includes a first right-side opening 231 and a second right-side opening 232. The first right-side opening 231 is located forward of the second right-side opening 232. The right-side portion 23a is open in the left-right direction by the first right-side opening 231 and the second right-side opening 232. In the vertical direction, the first right-side opening 231 and the second right-side opening 232 are located above the bottom portion 22. A ventilation fan 26 is provided at the first right-side opening 231. The ventilation fan 26 blows air from the interior to the exterior of the vehicle main body 21. Specifically, the ventilation fan 26 generates an air flow in the first right-side opening 231 from the interior to the exterior of the vehicle main body 21.

The left-side portion 23b includes an opening 27. In other words, the vehicle main body 21 includes the opening 27. The left-side portion 23b opens in the left-right direction through the opening 27. The opening 27 is located above the bottom portion 22 in the vertical direction.

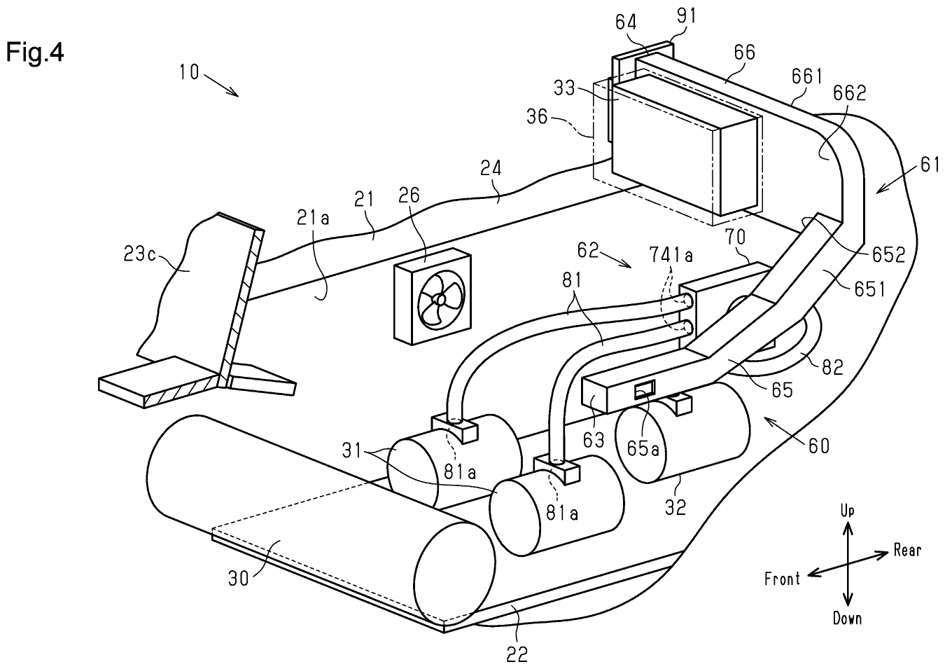

As shown in FIG. 4, the driving force transmitting device 30 is located on a part of the bottom portion 22 that is closer to the front end. The driving force transmitting device 30 is located below the front partition plate 23c in the vertical direction.

The counterweight 25 is used to balance the material-handling device 14 when the material-handling device 14 performs material handling.

As shown in FIGS. 1 and 2, the cabin 28 includes a top plate 28a, two side frames 28b, a bottom plate 28c, and a seat pedestal 28d. The cabin 28 extends upward from the upper surface of the vehicle main body 21. FIGS. 1 and 2 only show one of the side frames 28b, and the other side frame 28b is not shown. The bottom plate 28c is located on the upper surface of the vehicle main body 21. The driver's seat 29 is fixed to the upper surface of the seat pedestal 28d.

The battery 40 is provided at a position on the vehicle main body 21 that is rearward of the cabin 28.

### Accommodation Space 21a

The vehicle main body 21 includes an accommodation space 21a. The accommodation space 21a is formed inside the vehicle main body 21. The accommodation space 21a is defined by the bottom portion 22, the right-side portion 23a, the left-side portion 23b, the front partition plate 23c, the counterweight 25, the bottom plate 28c, and the seat pedestal 28d. The accommodation space 21a accommodates the two traction motors 31, the material-handling motor 32, and the motor controller 33. The two traction motors 31 and the material-handling motor 32 are each fixed to the upper surface of the bottom portion 22. The opening 27 connects the accommodation space 21a to the exterior of the vehicle main body 21.

The interior of the accommodation space 21a is ventilated by the ventilation fan 26. The ventilation fan 26 generates an air flow that enters the accommodation space 21a through the opening 27 and exits the accommodation space 21a through the first right-side opening 231.

### Traction Motors 31, Material-Handling Motor 32, and Motor Controller 33

As shown in FIGS. 3 and 4, the two traction motors 31 are fixed to the bottom portion 22 in the accommodation space 21a. The two traction motors 31 are fixed to parts of the upper surface of the bottom portion 22 that are closer to the front end. The number of the traction motors 31 may be changed. The two traction motors 31 are arranged in the left-right direction.

In the accommodation space 21a, the material-handling motor 32 is fixed to the bottom portion 22. The material-handling motor 32 is fixed to a part of the upper surface of the bottom portion 22 that is closer to the rear end. The material-handling motor 32 is provided rearward of the traction motors 31. The number of the material-handling motor 32 may be changed. In the left-right direction, the material-handling motor 32 is located in the vicinity of the center of the bottom portion 22.

As shown in FIG. 6, the motor controller 33 includes a control unit 34 and a heat exchanger 35. The control unit 34 is electrically connected to the traction motors 31 and the material-handling motor 32. The control unit 34 controls operation of the traction motors 31 and the material-handling motor 32. The control unit 34 includes three motor drivers (not shown). The three motor drivers respectively control operation of the two traction motors 31 and the material-handling motor 32.

The heat exchanger 35 has the shape of a plate. The control unit 34 is fixed to one surface of the heat exchanger 35 in the thickness direction, and fins 35c are provided on the other surface of the heat exchanger 35 in the thickness direction. The fins 35c extend rearward from the heat exchanger 35. The control unit 34 and the heat exchanger 35 are arranged in the thickness direction of the heat exchanger 35. The motor controller 33 includes the multiple fins 35c.

The motor controller 33 is located in a rear upper portion in the accommodation space 21a. The motor controller 33 is accommodated in the accommodation space 21a such that the thickness direction of the heat exchanger 35 agrees with the front-rear direction. The motor controller 33 is accommodated in the accommodation space 21a such that the control unit 34 is located forward of the heat exchanger 35.

The motor controller 33 is provided in a first cooling duct 61, which will be discussed below. The motor controller 33 is accommodated in a cover bracket 36. The motor controller 33 and the cover bracket 36 are fixed to the first cooling duct 61.

### Cooling Device 60

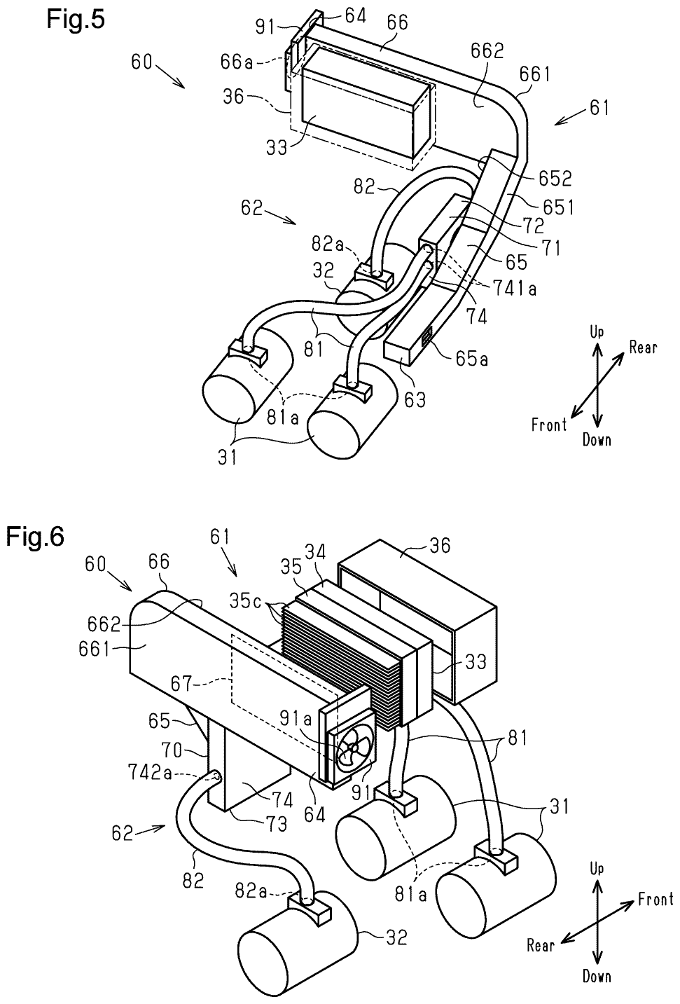

As shown in FIGS. 4 and 5, the cooling device 60 includes the first cooling duct 61 and a second cooling duct 62. The cooling device 60 is accommodated in the accommodation space 21a. In other words, the first cooling duct 61 is accommodated in the accommodation space 21a. The second cooling duct 62 is accommodated in the accommodation space 21a.

### First Cooling Duct 61

The first cooling duct 61 is a duct through which air flows. The first cooling duct 61 includes an inflow end 63 at a first end and an outflow end 64 at a second end. The first cooling duct 61 includes an introducing portion 65 extending in the front-rear direction in a left portion of the accommodation space 21a. The first cooling duct 61 includes a cooling portion 66 extending in the left-right direction at a portion closer to the rear end in the accommodation space 21a. The first cooling duct 61 is L-shaped as viewed in the vertical direction.

The introducing portion 65 includes the inflow end 63. The cooling portion 66 includes an outflow end 64.

The introducing portion 65 extends rearward and upward from the inflow end 63 to the cooling portion 66. A flow passage is formed inside the introducing portion 65. The cooling portion 66 extends from the introducing portion 65 to the outflow end 64, that is, from the left-side portion 23b toward the right-side portion 23a. A flow passage is formed inside the cooling portion 66.

### Introducing Portion 65

As shown in FIGS. 3 and 5, the outer surface of the introducing portion 65 includes a first introducing portion surface 651 and a second introducing portion surface 652, which face in the left-right direction. The first introducing portion surface 651 faces leftward. The second introducing portion surface 652 faces rightward. The second introducing portion surface 652 is opposite to the first introducing portion surface 651. The first introducing portion surface 651 faces the left-side portion 23b.

The introducing portion 65 includes an inlet port 65a at a position close to the inflow end 63. In other words, the first cooling duct 61 includes the inlet port 65a. The inlet port 65a opens in the first introducing portion surface 651. The inlet port 65a is located at a position facing the opening 27. The inlet port 65a opens toward the exterior of the accommodation space 21a through the opening 27. In other words, the inlet port 65a is connected to the exterior of the vehicle main body 21 through the opening 27. Air flows into the introducing portion 65 from the exterior of the vehicle main body 21 through the opening 27 and the inlet port 65a. The inlet port 65a may be connected to the opening 27. A slight gap may be provided between the inlet port 65a and the opening 27.

As shown in FIG. 8, the introducing portion 65 includes an outflow branch port 65b at a position closer to the inlet port 65a than the cooling portion 66 is. That is, the first cooling duct 61 includes the outflow branch port 65b. The outflow branch port 65b opens in the second introducing portion surface 652. The inlet port 65a and the outflow branch port 65b are connected to each other via the interior of the introducing portion 65.

### Cooling Portion 66

As shown in FIGS. 3 and 6, the outer surface of the cooling portion 66 includes a first cooling portion surface 661 and a second cooling portion surface 662, which face in the front-rear direction. The first cooling portion surface 661 faces rearward. The second cooling portion surface 662 faces forward. The second cooling portion surface 662 is opposite to the first cooling portion surface 661. The cooling portion 66 is connected to the introducing portion 65 at a portion of the second cooling portion surface 662 that is close to the introducing portion 65.

The cooling portion 66 includes a holding portion 67 on the second cooling portion surface 662. The holding portion 67 is a frame-shaped portion of the cooling portion 66 that opens frontward. The holding portion 67 is provided in a part of the cooling portion 66 that is closer to the outflow end 64 than the portion connected to the introducing portion 65 is.

The cooling portion 66 holds the motor controller 33 at the holding portion 67. The motor controller 33 is held at the holding portion 67 in a state in which the fins 35c are inserted into the cooling portion 66 from the opening of the holding portion 67. In other words, the motor controller 33 includes the fins 35c extending into the first cooling duct 61. The opening of the holding portion 67 is closed by the heat exchanger 35. The cooling portion 66 holds the motor controller 33 so that the control unit 34 is exposed to the exterior while accommodating the fins 35c. The cooling portion 66 is arranged rearward of the motor controller 33.

The motor controller 33 is fixed to the cooling portion 66 by the cover bracket 36. The motor controller 33 is accommodated in the space defined by the cover bracket 36 and the cooling portion 66.

The cooling portion 66 includes an outlet port 66a in a part close to the outflow end 64. That is, the first cooling duct 61 includes the outlet port 66a. The outlet port 66a opens rightward at the outflow end 64. The outlet port 66a faces the right-side portion 23a and opens to the exterior of the accommodation space 21a through the second right-side opening 232. In other words, the outlet port 66a is connected to the exterior of the vehicle main body 21 via the second right-side opening 232.

A flow passage that extends from the inlet port 65a to the outlet port 66a is formed inside the first cooling duct 61. The flow passage formed inside the first cooling duct 61 is connected to the exterior of the first cooling duct 61 through the inlet port 65a and the outlet port 66a. The flow passage formed inside the first cooling duct 61 is connected to the exterior of the first cooling duct 61 through the outflow branch port 65b. The inlet port 65a, the outflow branch port 65b, and the outlet port 66a are connected to each other by the flow passage formed inside the first cooling duct 61. The fins 35c are disposed in the flow passage formed inside the first cooling duct 61.

### Second Cooling Duct 62

As shown in FIGS. 3 and 5, the second cooling duct 62 includes a branch portion 70, two traction motor discharge pipes 81, and a material-handling motor discharge pipe 82.

### Branch Portion 70

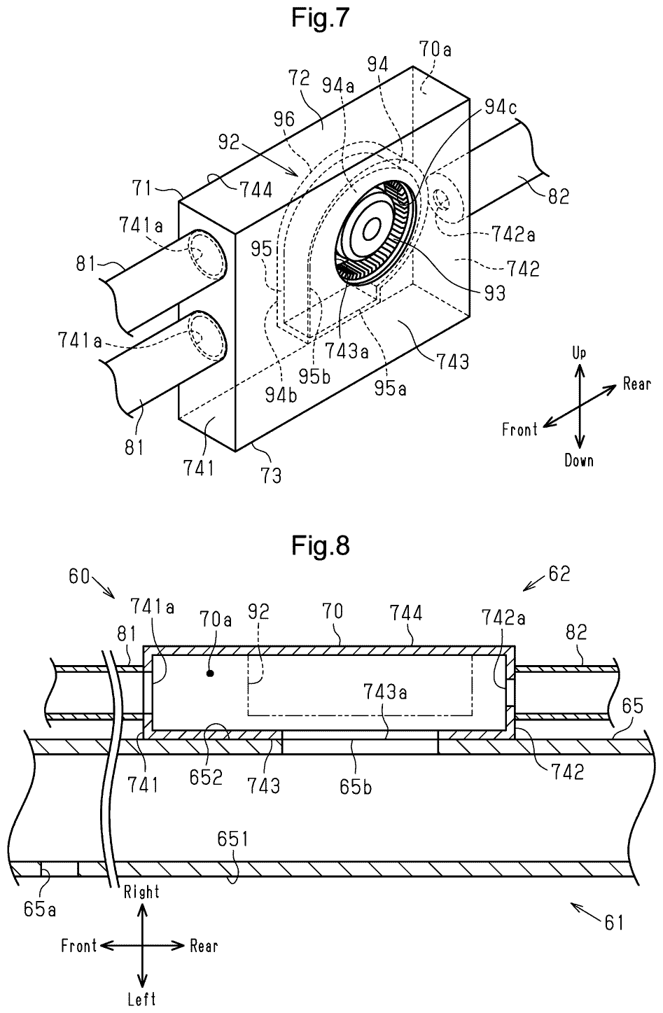

As shown in FIGS. 7 and 8, the branch portion 70 includes a branch housing 71. The branch housing 71 has the shape of a rectangular parallelepiped. A branch chamber 70a is formed inside the branch housing 71. The branch housing 71 includes an upper wall 72, a lower wall 73, and a peripheral wall 74. The branch chamber 70a is defined by the upper wall 72, the lower wall 73, and the peripheral wall 74. In other words, the branch portion 70 defines the branch chamber 70a.

The peripheral wall 74 includes a first opening wall 741, a second opening wall 742, a third opening wall 743, and a fourth wall 744.

The first opening wall 741 has the shape of an elongated plate. The longitudinal direction of the first opening wall 741 agrees with the vertical direction, and the thickness direction of the first opening wall 741 agrees with the front-rear direction. The first opening wall 741 includes two traction motor inlets 741a. The two traction motor inlets 741a each extend through the first opening wall 741 in the thickness direction. The two traction motor inlets 741a are arranged in the longitudinal direction of the first opening wall 741. The diameters of the two traction motor inlets 741a are equal to each other.

The second opening wall 742 has the shape of an elongated plate. The longitudinal direction of the second opening wall 742 agrees with the vertical direction, and the thickness direction of the second opening wall 742 agrees with the front-rear direction. The second opening wall 742 includes a material-handling motor inlet 742a. The material-handling motor inlet 742a extends through the second opening wall 742 in the thickness direction. The material-handling motor inlet 742a is located in the vicinity of the center of the second opening wall 742 in the longitudinal direction. The second opening wall 742 faces the first opening wall 741 in the front-rear direction. The thickness direction of the first opening wall 741 agrees with the thickness direction of the second opening wall 742. The diameter of the material-handling motor inlet 742a is smaller than the diameter of each of the two traction motor inlets 741a. In other words, the diameter of each of the traction motor inlets 741a is larger than the diameter of the material-handling motor inlet 742a.

The third opening wall 743 has the shape of an elongated plate. The longitudinal direction of the third opening wall 743 agrees with the front-rear direction, and the thickness direction of the third opening wall 743 agrees with the left-right direction. The third opening wall 743 includes an inflow branch port 743a. The branch portion 70 includes the inflow branch port 743a. In other words, the second cooling duct 62 includes the inflow branch port 743a. The inflow branch port 743a extends through the third opening wall 743 in the thickness direction. The inflow branch port 743a is located in the vicinity of the center of the third opening wall 743 in the longitudinal direction.

The third opening wall 743 is connected to the first opening wall 741 at one of the two edges at the two ends in the longitudinal direction, and is connected to the second opening wall 742 at the other edge. The longitudinal direction of the third opening wall 743 agrees with the thickness direction of the first opening wall 741. The longitudinal direction of the third opening wall 743 agrees with the thickness direction of the second opening wall 742. The thickness direction of the third opening wall 743 is orthogonal to the thickness direction of the first opening wall 741 and the thickness direction of the second opening wall 742. The opening direction of the inflow branch port 743a is orthogonal to the opening direction of the two traction motor inlets 741a and the opening direction of the material-handling motor inlet 742a.

The third opening wall 743 is connected to the upper wall 72 at one of the two edges at the two ends in the vertical direction, and is connected to the lower wall 73 at the other edge.

The fourth wall 744 is connected to the first opening wall 741 at one of the two edges at the two ends in the longitudinal direction, and is connected to the second opening wall 742 at the other edge. The fourth wall 744 faces the third opening wall 743. The thickness direction of the third opening wall 743 agrees with the thickness direction of the fourth wall 744. The fourth wall 744 is connected to the upper wall 72 at one of the two edges at the two ends in the vertical direction, and is connected to the lower wall 73 at the other edge.

### Traction Motor Discharge Pipes and Material-Handling Motor Discharge Pipe

As shown in FIGS. 4, 7, and 8, the branch portion 70 is connected to the two traction motor discharge pipes 81. In other words, the second cooling duct 62 includes the traction motor discharge pipes 81. Each of the two traction motor discharge pipes 81 is connected to the traction motor inlet 741a and opens in the branch chamber 70a.

Each of the two traction motor discharge pipes 81 includes a traction motor discharge port 81a, which is a discharge port. That is, the second cooling duct 62 includes the two traction motor discharge ports 81a. Each of the two traction motor discharge pipes 81 is connected to the branch portion 70 at a first end and includes the traction motor discharge port 81a at a second end. Each traction motor discharge port 81a opens toward the traction motors 31.

The traction motor discharge pipe 81 that extends to the traction motor 31 located closer to the right-side portion 23a is connected to one of the two traction motor inlets 741a that is closer to the upper wall 72. The traction motor discharge pipe 81 that extends to the traction motor 31 located closer to the left-side portion 23b is connected to one of the two traction motor inlets 741a that is closer to the lower wall 73. That is, the second cooling duct 62 includes the traction motor discharge pipes 81, which extend from the traction motor inlets 741a, which open in the branch chamber 70a, to the traction motor discharge ports 81a. The inner diameters of the two traction motor discharge pipes 81 are the same.

As shown in FIGS. 3 and 7, the material-handling motor discharge pipe 82 is connected to the branch portion 70. That is, the second cooling duct 62 includes the material-handling motor discharge pipe 82. The material-handling motor discharge pipe 82 is connected to the material-handling motor inlet 742a and opens in the branch chamber 70a.

As shown in FIG. 6, the material-handling motor discharge pipe 82 includes a material-handling motor discharge port 82a, which is a discharge port. That is, the second cooling duct 62 includes the material-handling motor discharge port 82a. The material-handling motor discharge pipe 82 is connected to the branch portion 70 at a first end and includes the material-handling motor discharge port 82a at a second end. The material-handling motor discharge port 82a opens toward the material-handling motor 32. That is, the second cooling duct 62 includes the material-handling motor discharge pipe 82, which extends from the material-handling motor inlet 742a, which opens in the branch chamber 70a, to the material-handling motor discharge port 82a.

Positional Relationship between the First Cooling Duct 61 and the Second Cooling Duct 62

When the branch portion 70 is fixed to the introducing portion 65, the second cooling duct 62 is connected to the first cooling duct 61. The branch portion 70 is disposed at a position where the outer surface of the third opening wall 743 and the second introducing portion surface 652 face each other. The branch portion 70 is fixed to the introducing portion 65 such that the inflow branch port 743a and the outflow branch port 65b are connected to each other. That is, the second cooling duct 62 includes the inflow branch port 743a, which is connected to the outflow branch port 65b. The branch chamber 70a is thus connected to the flow passage formed in the first cooling duct 61 through the outflow branch port 65b.

In the cooling device 60, the first opening wall 741 and the second opening wall 742 are arranged in the front-rear direction. Also, in the cooling device 60, the first opening wall 741 is located forward of the second opening wall 742. That is, the traction motor inlets 741a open toward the traction motors 31 in the front-rear direction. The material-handling motor inlet 742a opens toward the material-handling motor 32 in the front-rear direction.

### First Fan 91

As shown in FIG. 6, the cooling device 60 includes a first fan 91 provided in a first cooling duct 61. The first fan 91 includes first blades 91a. The first fan 91 rotates the first blades 91a to blow air. The first fan 91 blows air in a direction orthogonal to the rotation direction of the first blades 91a.

As shown in FIGS. 6 and 3, the first fan 91 is provided in the first cooling duct 61. The first fan 91 is disposed at the outflow end 64. As shown in FIG. 3, the first fan 91 is located at a position facing the second right-side opening 232. The first fan 91 is located at a position where the first blades 91a and the second right-side opening 232 face each other. The first fan 91 is located between the outlet port 66a and the second right-side opening 232. The first fan 91 blows air in the opening direction of the outlet port 66a using the first blades 91a. The first fan 91 blows air from the outlet port 66a to the second right-side opening 232. The first fan 91 discharges air from the interior of the cooling portion 66 through the outlet port 66a. In other words, the first fan 91 discharges the air that has flowed in through the inlet port 65a from the outlet port 66a. That is, the first cooling duct 61 includes the outlet port 66a, from which the air flowing into the first cooling duct 61 through the inlet port 65a flows out.

In this manner, the first fan 91 generates an air flow from the inlet port 65a to the outlet port 66a in the first cooling duct 61. In other words, the first cooling duct 61 includes the first fan 91, which generates an air flow from the inlet port 65a to the outlet port 66a in the first cooling duct 61.

The air in the first cooling duct 61 flows from the inlet port 65a to the outlet port 66a under the action of the first fan 91. The first cooling duct 61 includes the inlet port 65a at the upstream side and the outlet port 66a at the downstream side. In other words, the first cooling duct 61 includes the outflow branch port 65b in a section that is downstream of the inlet port 65a and upstream of the outlet port 66a.

### Second Fan 92

As shown in FIG. 7, the cooling device 60 includes a second fan 92 provided in the branch portion 70 of the second cooling duct 62. The second fan 92 includes second blades 93 and a fan housing 96. The fan housing 96 includes a blade accommodating portion 94 and an ejection portion 95. The second fan 92 is a blower fan.

The blade accommodating portion 94 is columnar. The blade accommodating portion 94 includes a suction surface 94a at one end in the axial direction and an attachment surface 94b at the other end in the axial direction. The blade accommodating portion 94 defines a blade accommodating chamber 94c, which opens in the suction surface 94a.

The ejection portion 95 is connected to the blade accommodating portion 94. The ejection portion 95 is a tubular body extending in a direction orthogonal to the axial direction of the blade accommodating portion 94. The ejection portion 95 is connected to the blade accommodating portion 94 at a first end and includes an ejection port 95a at a second end. An ejection passage 95b is formed in the ejection portion 95. The ejection port 95a is connected to the blade accommodating chamber 94c by the ejection passage 95b. In other words, the blade accommodating chambers 94c opens in the suction surface 94a in the axial direction of the blade accommodating portion 94 and is connected to the exterior by the ejection port 95a in a direction orthogonal to the axial direction of the blade accommodating portion 94.

The fan housing 96 accommodates the second blades 93 in the blade accommodating chamber 94c. The second blades 93 are disposed in the fan housing 96 in a manner rotatable about a rotation axis extending in the axial direction of the blade accommodating portion 94. The second fan 92 rotates the second blades 93 to draw air into the blade accommodating chamber 94c through the opening in the suction surface 94a. The air drawn into the blade accommodating chamber 94c is introduced to the ejection passage 95b and then discharged through the ejection port 95a.

The second fan 92 is accommodated in the branch chamber 70a. The second opening wall 742 faces the first opening wall 741 with the second fan 92 between the second opening wall 742 and the first opening wall 741. The second fan 92 is disposed in the branch portion 70 such that the attachment surface 94b faces the fourth wall 744, and the suction surface 94a faces the third opening wall 743. The second fan 92 is disposed in the branch portion 70 such that the ejection port 95a is open toward the lower wall 73. In other words, the ejection port 95a opens in a direction orthogonal to the thickness direction of each of the first opening wall 741, the second opening wall 742, and the third opening wall 743.

The second fan 92 is fixed to the third opening wall 743 and the fourth wall 744 with bolts (not shown). The second fan 92 is disposed in the branch portion 70 such that the ejection port 95a is separated from the lower wall 73.

The opening of the suction surface 94a and the inflow branch port 743a are arranged in the thickness direction of the third opening wall 743. Specifically, the second fan 92 rotates the second blades 93 to draw air into the blade accommodating chamber 94c from the exterior of the branch portion 70 through the inflow branch port 743a. In other words, the second fan 92 draws air from the inflow branch port 743a toward the branch chamber 70a.

The second fan 92 discharges the air drawn into the blade accommodating chamber 94c from the ejection port 95a toward the lower wall 73. The second fan 92 draws in air through the inflow branch port 743a and discharges the air to the branch chamber 70a. In the branch chamber 70a, the second fan 92 ejects air in a direction orthogonal to the thickness direction of each of the first opening wall 741, the second opening wall 742, and the third opening wall 743.

The air introduced into the branch chamber 70a through the inflow branch port 743a flows out of the branch chamber 70a through the two traction motor inlets 741a and the material-handling motor inlet 742a. The air that has flowed from the branch chamber 70a to the traction motor inlets 741a flows into the traction motor discharge pipes 81. The air that has flowed into the traction motor discharge pipes 81 is discharged through the traction motor discharge ports 81a. The air that has flowed from the branch chamber 70a to the material-handling motor inlet 742a flows into the material-handling motor discharge pipe 82. The air that has flowed into the material-handling motor discharge pipe 82 is discharged through the material-handling motor discharge port 82a. That is, the second cooling duct 62 includes the traction motor discharge ports 81a and the material-handling motor discharge port 82a, through which air that has flowed in through the inflow branch port 743a is discharged. The second fan 92 generates, in the second cooling duct 62, air flow from the inflow branch port 743a to the traction motor discharge ports 81a and to the material-handling motor discharge port 82a.

### Operation of the Present Embodiment

Operation of the present embodiment will now be described together with operation of the forklift 10 and the cooling device 60.

The forklift 10 is operated by driving the drive motors M. Specifically, the forklift 10 travels by driving the drive wheels 12 using the traction motors 31. The forklift 10 performs a material handling operation by operating the material-handling device 14 using the material-handling motor 32.

As the drive motors M are driven, the drive motors M generate heat. The control unit 34 generates heat due to operation of the motor controller 33. The heat generated by the drive motors M and the control unit 34 increases the temperature of the air in the accommodation space 21a. The heat generated by the control unit 34 is transferred to the fins 35c via the heat exchanger 35.

When the forklift 10 is in operation, the ventilation fan 26, the first fan 91, and the second fan 92 are operating. The ventilation fan 26 discharges the air in the accommodation space 21a from the first right-side opening 231 to the exterior of the vehicle main body 21.

Air flows out through the first right-side opening 231. Also, air flows into the opening 27 from the exterior of the vehicle main body 21. The air that has flowed into the opening 27 flows into the cooling device 60 through the inlet port 65a. The air that has flowed into the opening 27 flows into the first cooling duct 61 through the inlet port 65a.

The air that has flowed into the first cooling duct 61 through the inlet port 65a is split into a flow to the outlet port 66a by the action of the first fan 91 and a flow flowing out through the outflow branch port 65b by the action of the second fan 92.

The air flowing toward the outlet port 66a passes through the fins 35c in a section of the first cooling duct 61 that is downstream of the outflow branch port 65b and upstream of the outlet port 66a. Heat is transferred from the fins 35c to the air that has passed through the fins 35c. In other words, the fins 35c transfer the heat generated by the control unit 34 to the air flowing through the cooling portion 66. The motor controller 33 is connected to the first cooling duct 61 so as to exchange heat with the air flowing in a section that is downstream of the outflow branch port 65b and upstream of the outlet port 66a. The air that has passed through the fins 35c flows out of the first cooling duct 61 through the outlet port 66a under the action of the first fan 91. The air that has flowed out through the outlet port 66a passes through the second right-side opening 232 and is then discharged to the exterior of the vehicle main body 21.

Some of the air that has flowed in through the inlet port 65a flows out through the outflow branch port 65b and flows into the inflow branch port 743a. The air that has flowed out through the outflow branch port 65b flows toward the inflow branch port 743a under the action of the second fan 92. The air that has flowed into the inflow branch port 743a is drawn into the branch chamber 70a and then flows into the traction motor discharge pipes 81 and the material-handling motor discharge pipe 82.

The second fan 92 generates, in the second cooling duct 62, an air flow from the inflow branch port 743a toward the traction motor discharge pipes 81 and an air flow from the inflow branch port 743a toward the material-handling motor discharge pipe 82. The air that has flowed into the traction motor discharge pipes 81 flows from the traction motor inlets 741a to the traction motor discharge ports 81a. The air that has flowed into the material-handling motor discharge pipe 82 flows from the material-handling motor inlet 742a to the material-handling motor discharge port 82a.

The air that has flowed through the traction motor discharge pipes 81 is discharged from the traction motor discharge ports 81a toward the traction motors 31. The air discharged to the traction motors 31 flows along the traction motors 31 and is then discharged to the exterior of the vehicle main body 21 through the first right-side opening 231. Heat is transferred from the traction motors 31 to the air passing through the traction motors 31. The traction motors 31 are connected to the second cooling duct 62 so as to be cooled by the air discharged from the traction motor discharge ports 81a.

The air that has flowed through the material-handling motor discharge pipe 82 is discharged toward the material-handling motor 32 through the material-handling motor discharge port 82a. The air discharged to the material-handling motor 32 flows along the material-handling motor 32 and is then discharged to the exterior of the vehicle main body 21 through the first right-side opening 231. The air passing through the material-handling motor 32 receives heat from the material-handling motor 32. The material-handling motor 32 is connected to the second cooling duct 62 so as to be cooled by the air discharged through the material-handling motor discharge port 82a. Accordingly, the drive motors M are connected to the second cooling duct 62 so as to be cooled by air discharged through the traction motor discharge ports 81a and the material-handling motor discharge port 82a.

### Advantages of the Present Embodiment

The present embodiment has the following advantages.

(1) The cooling device 60 cools the motor controller 33 using the air that has flowed into the first cooling duct 61 through the opening 27. The cooling device 60 splits some of the air that has flowed into the opening 27 to an air flow to the second cooling duct 62 from the first cooling duct 61. The cooling device 60 is capable of cooling the drive motors M using the air flowing into the second cooling duct 62. The cooling device 60 uses the first cooling duct 61 and the second cooling duct 62 to separately generate an air flow for cooling the motor controller 33 and an air flow for cooling the drive motors M. Since the cooling device 60 delivers air to each of the motor controller 33 and the drive motors M in a concentrated manner, the drive motors M and the motor controller 33 are cooled efficiently. As described above, the forklift 10 improves the cooling performance for the drive motors M and the motor controller 33.

For example, the forklift 10 may be used as an alternative to an engine-powered forklift. In this case, the drive motors M and the motor controller 33 are supplied with greater electrical power from the battery 40 than in a case in which the forklift 10 is not used as an alternative to an engine-powered forklift. As a result, the drive motors M and the motor controller 33 generate a relatively large amount of heat when the forklift 10 is used as an alternative to an engine-powered forklift. The forklift 10 can be used even when significant heat is generated in the drive motors M and the motor controller 33. This is achieved by improving the cooling performance for the drive motors M and the motor controller 33 using the cooling device 60. Consequently, the forklift 10, with the improved cooling performance for the drive motors M and the motor controller 33, is suitable for use as an alternative to an engine-powered forklift.

(2) The first fan 91 causes the air drawn in through the inlet port 65a to flow toward a portion of the first cooling duct 61 that cools the motor controller 33. The first fan 91 discharges the air that has cooled the motor controller 33 through the outlet port 66a. The second fan 92 causes the air flowing through the first cooling duct 61 to flow from the inflow branch port 743a toward the second cooling duct 62. The second fan 92 causes air to flow from the inflow branch port 743a to each of the traction motor discharge ports 81a and the material-handling motor discharge port 82a. As a result, the forklift 10 cools the motor controller 33 and the drive motors M more efficiently than in a case in which the first fan 91 and the second fan 92 are not provided.

(3) The cooling device 60 includes the traction motor discharge pipes 81 and the material-handling motor discharge pipe 82. Thus, the traction motors 31 and the material-handling motor 32 are cooled by air that has passed through different pipes. As a result, each of the traction motors 31 and the material-handling motor 32 is cooled more efficiently than in a case in which air is delivered first to the traction motors 31 and then to the material-handling motor 32, or vice versa.

(4) The second fan 92 ejects the drawn air in a direction orthogonal to the thickness direction of the first opening wall 741 and the thickness direction of the second opening wall 742. Accordingly, the second fan 92 allows air to be introduced to the branch portion 70 without unevenly directing the air inflow toward either the traction motor inlets 741a or the material-handling motor inlet 742a.

(5) The direction in which air is ejected by the second fan 92 is orthogonal to the thickness direction of the third opening wall 743. For example, if the direction in which air is ejected by the second fan 92 is parallel to the thickness direction of the third opening wall 743, a space for receiving the air needs to be created in the branch chamber 70a in the thickness direction of the third opening wall 743. Since the branch chamber 70a needs to be enlarged in the thickness direction of the third opening wall 743, the branch portion 70 may be enlarged in that direction. However, in a case in which the direction in which air is ejected by the second fan 92 is orthogonal to the thickness direction of the third opening wall 743, the branch chamber 70a does not need to be enlarged in the thickness direction of the third opening wall 743. In the forklift 10, the direction in which air is ejected by the second fan 92 is set to be orthogonal to the thickness direction of the third opening wall 743. This prevents the size of the branch portion 70 from being increased.

(6) In the forklift 10, the traction motors 31 generate more heat than the material-handling motor 32. In the forklift 10, it is desired that the traction motors 31 be cooled more efficiently than the material-handling motor 32. The diameter of each of the traction motor inlets 741a is larger than the diameter of the material-handling motor inlet 742a. Thus, the air introduced into the branch chamber 70a by the second fan 92 flows more into the traction motor inlets 741a than into the material-handling motor inlet 742a. The forklift 10 allows a greater amount of air to flow into the traction motor discharge pipes 81 than into the material-handling motor discharge pipe 82. The forklift 10 cools the traction motors 31 more efficiently than the material-handling motor 32.

(7) The motor controller 33 increases the area exposed to the air flowing through the first cooling duct 61 as compared to a configuration that does not include the fins 35c. As a result, the forklift 10 cools the motor controller 33 more efficiently than in a case in which the motor controller 33 does not include the fins 35c.

### Modifications

The above-described embodiment may be modified as described below. The above-described embodiment and the following modifications can be combined as long as the combined modifications remain technically consistent with each other.

The motor controller 33 does not necessarily need to include the fins 35c. In this case, the heat exchange between the motor controller 33 and the air flowing through the first cooling duct 61 is performed on a surface of the heat exchanger 35 opposite to a surface on which the control unit 34 is disposed.

The diameter of each of the traction motor inlets 741a may be less than or equal to the diameter of the material-handling motor inlet 742a.

The branch portion 70 may include traction motor inlets 741a at parts of the peripheral wall 74 that are different from the first opening wall 741. For example, the traction motor inlets 741a may be provided in the fourth wall 744. In this case, the traction motor inlets 741a are preferably provided at a part of the fourth wall 744 that is closer to the traction motors 31 in the front-rear direction.

The branch portion 70 may include the material-handling motor inlet 742a at a part in the peripheral wall 74 that is different from the second opening wall 742. For example, the material-handling motor inlet 742a may be provided in the fourth wall 744. In this case, the material-handling motor inlet 742a is preferably provided in a part of the fourth wall 744 that is closer to the material-handling motor 32 in the front-rear direction.

The branch portion 70 may include the inflow branch port 743a in a part of the peripheral wall 74 that is different from the third opening wall 743. In this case, the inflow branch port 743a is connected to the outflow branch port 65b by, for example, a pipe.

The second fan 92 may eject the air drawn in through the inflow branch port 743a in a direction different from the direction orthogonal to the thickness direction of each of the first opening wall 741, the second opening wall 742, and the third opening wall 743. For example, the second fan 92 may eject air toward the first opening wall 741.

The second fan 92 does not necessarily need to be a blower fan. For example, the second fan 92 may be provided in the inflow branch port 743a and may be a fan that blows air from the third opening wall 743 toward the fourth wall 744. In other words, the second fan 92 may be modified as long as the second fan 92 is capable of drawing in air from the exterior of the branch portion 70 toward the branch chamber 70a through the inflow branch port 743a.

The vehicle loads W may include either the drive wheels 12 or the material-handling device 14. For example, the vehicle loads W may include only the drive wheels 12. In this case, the drive motors M are only the traction motors 31. The discharge ports may include only the traction motor discharge ports 81a, and the second cooling duct 62 includes only the traction motor discharge pipes 81.

The first opening wall 741 may include only one traction motor inlet 741a. In this case, the second cooling duct 62 includes only one traction motor discharge pipe 81. The traction motor discharge pipe 81 extends from the single traction motor inlet 741a. The traction motor discharge pipe 81 is branched into two traction motor discharge ports 81a at the middle of the flow passage.

The first fan 91 does not necessarily need to be disposed at the outflow end 64. For example, the first fan 91 may be disposed between the introducing portion 65 and the cooling portion 66. The first cooling duct 61 does not necessarily include the first fan 91. For example, the first fan 91 may be disposed at the second right-side opening 232.

The forklift 10 does not necessarily need to include the first fan 91.

The second cooling duct 62 does not necessarily need to include the second fan 92 in the branch chamber 70a. The second fan 92 may be disposed outside the second cooling duct 62. For example, the second fan 92 may be disposed in the outflow branch port 65b. The cooling device 60 may include a pipe connecting the inflow branch port 743a and the outflow branch port 65b to each other, and the second fan 92 may be disposed in that pipe.

The forklift 10 does not necessarily need to include the second fan 92.

The second cooling duct 62 does not necessarily need to include branch portion 70. In this case, the traction motor discharge pipes 81 and the material-handling motor discharge pipe 82 are directly connected to each other. The inflow branch port 743a is provided either in the traction motor discharge pipes 81 or the material-handling motor discharge pipe 82.

The outflow branch port 65b does not necessarily need to be provided at a part of the introducing portion 65 that is closer to the inlet port 65a than the cooling portion 66 is. For example, the outflow branch port 65b may be provided in a part of the cooling portion 66 that is closer to the introducing portion 65 than the outlet port 66a is. In this case, the branch portion 70 may be provided in the cooling portion 66. That is, the outflow branch port 65b may be disposed at any position in the first cooling duct 61 that is downstream of the inlet port 65a and upstream of the outlet port 66a.

The motor controller 33 does not necessarily need to be disposed in a part of the cooling portion 66 that is closer to the outlet port 66a than the introducing portion 65 is. For example, the motor controller 33 may be disposed in the introducing portion 65. In other words, the motor controller 33 may be disposed at any position in the first cooling duct 61 that is upstream of the outlet port 66a and downstream of the outflow branch port 65b.

The second right-side opening 232 may be omitted. In this case, the air delivered from the second fan 92 is discharged into the accommodation space 21a. The air discharged into the accommodation space 21a is delivered forward and then discharged from the first right-side opening 231 by the ventilation fan 26, or delivered rearward and then discharged via gap or hole (not shown).

The second right-side opening 232 does not necessarily need to face the first fan 91.

The vehicle loads W are not limited to the drive wheels 12 and the material-handling device 14. For example, the vehicle loads W may include the driving force transmitting device 30. In this case, the second cooling duct 62 includes a pipe that discharges air toward the driving force transmitting device 30. The forklift 10 may include a pipe that is connected to the branch portion 70 and discharges air supplied from the branch portion 70 toward the driving force transmitting device 30. In the forklift 10, the driving force transmitting device 30 is connected to the second cooling duct 62 so as to be cooled by air discharged from the discharge port of the second cooling duct 62.

Inside the vehicle main body 21, the positional relationship of the traction motors 31, the material-handling motor 32, and the motor controller 33 is not limited to that in the above-described embodiment. For example, the positions of the traction motors 31 and the material-handling motor 32 in the front-rear direction may be switched. In this case, the shapes of the first cooling duct 61 and the second cooling duct 62 are changed in accordance with the positions of the traction motors 31, the material-handling motor 32, and the motor controller 33.

The position of the opening 27 in the vehicle main body 21 is not limited to the one described in the embodiment. For example, the opening 27 may be provided in the front part of the vehicle main body 21.

The industrial vehicle is not limited to the forklift 10. For example, the industrial vehicle may be a tow vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An industrial vehicle, comprising:
a vehicle body provided with a vehicle load and a battery;
a drive motor that is configured to receive electric power from the battery so as to drive the vehicle load; and
a motor controller configured to control the drive motor, wherein
the vehicle body includes:
an accommodation space that accommodates the drive motor and the motor controller; and
an opening that connects the accommodation space to an exterior of the vehicle body,
the accommodation space accommodates a first cooling duct and a second cooling duct,
the first cooling duct includes:
an inlet port connected to the exterior of the vehicle body through the opening;
an outlet port through which air that has flowed into the first cooling duct through the inlet port flows out from the first cooling duct; and
an outflow branch port in a section downstream of the inlet port and upstream of the outlet port,
the second cooling duct includes:
an inflow branch port connected to the outflow branch port; and
a discharge port through which air that has flowed into the second cooling duct through the inflow branch port is discharged from the second cooling duct,
the motor controller is connected to the first cooling duct so as to exchange heat with air flowing in a section that is downstream of the outflow branch port and upstream of the outlet port, and
the drive motor is connected to the second cooling duct so as to be cooled by air discharged from the discharge port.

2. The industrial vehicle according to claim 1, wherein
a first fan is provided in the first cooling duct, the first fan being configured to generate, in the first cooling duct, an air flow from the inlet port to the outlet port,
the second cooling duct includes a branch portion including the inflow branch port,
the branch portion defines a branch chamber that is connected to the outflow branch port, and
the branch chamber accommodates a second fan configured to generate, in the second cooling duct, an air flow from the inflow branch port to the discharge port.

3. The industrial vehicle according to claim 2, wherein
the vehicle load includes a material-handling device and a drive wheel that are provided on the vehicle body,
the drive motor includes a traction motor configured to drive the drive wheel and a material-handling motor configured to operate the material-handling device,
the discharge port includes a traction motor discharge port and a material-handling motor discharge port, and
the second cooling duct includes:
a traction motor discharge pipe that extends from a traction motor inlet that opens in the branch chamber to the traction motor discharge port; and
a material-handling motor discharge pipe that extends from a material-handling motor inlet that opens in the branch chamber to the material-handling motor discharge port.

4. The industrial vehicle according to claim 3, wherein
the branch portion includes:
a first opening wall in which the traction motor inlet is provided;
a second opening wall in which the material-handling motor inlet is provided, the second opening wall facing the first opening wall with the second fan between the second opening wall and the first opening wall; and
a third opening wall in which the inflow branch port is provided, the third opening wall extending between the first opening wall and the second opening wall,
the third opening wall has a thickness direction that is orthogonal to a thickness direction of the first opening wall and a thickness direction of the second opening wall, and
the second fan is a blower fan that is configured to
draw air into the branch chamber from the inflow branch port, and
in the branch chamber, eject air in a direction orthogonal to the thickness direction of each of the first opening wall, the second opening wall, and the third opening wall.

5. The industrial vehicle according to claim 3, wherein a diameter of the traction motor inlet is larger than a diameter of the material-handling motor inlet.

6. The industrial vehicle according to claim 1, wherein the motor controller includes multiple fins extending to an interior of the first cooling duct.
